(19) United States
(12) Patent Application Publication
(10) Pub. No.: US 2008/0192914 A1
(43) Pub. Date: Aug. 14, 2008

(54) METHOD, SYSTEM AND SIGNALLING POINT FOR TRANSPORTING DUPU MESSAGE

(75) Inventors: Lin Lin, Shenzhen (CN); Jingli Shao, Shenzhen (CN); Xiaojun Mo, Shenzhen (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Huawei Technologies Co., Ltd., Shenzhen (CN)

(21) Appl. No.: 11/957,065

(22) Filed: Dec. 14, 2007

(30) Foreign Application Priority Data
Feb. 12, 2007 (CN) 200710084509.9

(51) Int. Cl. H04M 3/42

(52) U.S. Cl. 379/211.02

(57) ABSTRACT

The present invention provides a method for transporting a Destination User Part Unavailable (DUPU) message, including: carrying along with a DUPU message the originating point code corresponding to the originating signalling point which has triggered the DUPU message by a first signalling point in which a user part is unavailable and returning the DUPU message to a second signalling point; and forwarding, by the second signalling point upon receiving the DUPU message, the received DUPU message according to the originating point code which is contained in the message. The present invention also provides a system and a signalling point for transporting a DUPU message. According to the present invention, correct transmission of the DUPU message is be attained with the workload in forwarding messages lightened and network consumption reduced.

### FIELD OF THE INVENTION

The present invention relates to Signalling Network Management (SNM) technologies in telecommunications system, and particularly to a method, system and signalling point for transporting a Destination User Part Unavailable (DUPU) message.

### BACKGROUND OF THE INVENTION

Signalling Transport (SIGTRAN) protocol stack is a standard of interconnection between Public Switched Telephone Network (PSTN) signalling network and Internet Protocol (IP) network, defined by the SIGTRAN workgroup for transport of conventional Switched Circuit Network (SCN) signalling over IP networks. The SIGTRAN protocol stack supports standard inter-layer primitive interfaces defined in the SCN signalling protocol hierarchy model to ensure utilization of the existing SCN signalling application without modification. The SIGTRAN protocol stack uses the standard IP transport protocol as the transmission bottom layer and satisfies the special transmission requirements of the SCN signalling by adding its own function.

The primary functions of the SIGTRAN protocol stack are transport and adaptation, in which the transport function is achieved by Stream Control Transmission Protocol (SCTP) and the adaptation function is achieved by either MTP2-User Adaptation Layer (M2UA) protocol which performs signalling link level functions or MTP3-User Adaptation Layer (M3UA) protocol which performs signalling network level functions. In the SNM, M3UA maintains network status through an SNM message. The SNM message includes: Destination Unavailable (DUNA), Destination Available (DAVA), Destination State Audit (DAUD), Signalling Congestion (SCON) and Destination User Part Unavailable (DUPU). The DUPU message is used for informing the originating signalling point that the User Part of destination signalling points are unavailable, which enables the originating signalling point to take corresponding actions.

The structure of DUPU message is shown in Table 1, including the following fields: a Network Appearance field, a Routing Context field, an Affected PC field, a User/Cause field and an INFO String field. Corresponding tags and lengths of the fields are also given in Table 1. The Affected PC field is used for indicating the affected destination signalling point code of the signalling point where the User Part is unavailable.

TABLE 1

| | | | |
|---|---|---|---|
| 0 | 1 | 2 | 3 |

| | |
|---|---|
| Tag = 0x0200 | Length = 8 |

Network Appearance

| | |
|---|---|
| Tag = 0x0006 | Length |

Routing Context

| | |
|---|---|
| Tag = 0x0012 | Length = 8 |

| | |
|---|---|
| mask = 0 | Affected PC |

| | |
|---|---|
| Tag = 0x0204 | Length = 8 |
| Cause | User |
| Tag = 0x0004 | Length |

INFO String

As shown in Table 1, a DUPU message may not be delivered properly since the destination of the message is not specified in the DUPU message. For example, in the network structure shown in FIG. 1, the three Signalling Points (SPs), SP 110, SP 120 and SP 130, exchange messages with SP 140 via Signalling Gateway (SG) 150. When the M3UA layer of SP 140 receives a DATA message from SP 110 and detects that the DATA message may not be delivered to the designated upper-level user, i.e. a User Part is unavailable, SP 140 returns a DUPU message to SP 110 so that SP 110 may take corresponding actions. The Affected PC field of the DUPU message carries the Signalling Point Code (SPC) of SP 140. However, since the DUPU message does not indicate the destination signalling point which the DUPU message needs to reach, when the DUPU message returned by SP 140 reaches the SG 150, the SG 150 may be unable to determine the destination of the DUPU message, and as a result, the message may not reach SP 110 correctly. In such a case, SP 110 may never know the User Part failure on SP 140, and will continue sending the DATA message to the user of SP 140, and the DATA message will be forwarded to SP 140 and then be discarded, which not only increases the workload of SG 150 in the forwarding process, but also wastes transporting resources.

### SUMMARY OF THE INVENTION

The present invention provides a solution to one or all of the above mentioned problems through an inventive method, system and signalling point for transporting a DUPU message so that the DUPU message may be forwarded correctly.

A method for transporting a Destination User Part Unavailable (DUPU) message includes:

returning, by a first signalling point in which a User Part is unavailable, a DUPU message to a second signalling point, the DUPU message carrying a originating point code corresponding to the originating signalling point which has trigged the DUPU message; and

forwarding, by the second signalling point, the DUPU message according to the originating point code which is carried along with the DUPU message upon receiving the DUPU message.

The forwarding of the DUPU message by the second signalling point includes:

judging, by the second signalling point, whether the originating point code which is carried along with the DUPU message is identical with the signalling point code (SPC) of the second signalling point; and

handling the received DUPU message locally if the originating point code is identical with the SPC of the second signalling point, or

forwarding the received DUPU message to the signalling point corresponding to the originating point code if the originating point code is not identical with the SPC of the second signalling point.

The carrying along with the DUPU message the originating point code by the first signalling point includes:

adding, by the first signalling point, a field for carrying the originating point code in the DUPU message, and sending the DUPU message.

An alternative embodiment of the carrying along with the DUPU message the originating point code by the first signalling point includes:

extending, by the first signalling point, the INFO String field of the DUPU message to carry the origination point code and sending the DUPU message carrying the origination point code in the extended INFO String field.

A system for transporting a Destination User Part Unavailable (DUPU) message includes: a first signalling point and a second signalling point;

the first signalling point is capable of carrying along with a DUPU message the origination point code corresponding to the originating signalling point which has triggered the DUPU message when a User Part is unavailable, and returning the DUPU message to the second signalling point;

the second signalling point is capable of receiving the DUPU message from the first signalling point, and forwarding the DUPU message according to the originating point code which is carried along with the DUPU message.

The second signalling point includes: a sending and receiving unit and a forwarding unit, and,

the sending and receiving unit is capable of receiving the DUPU message from the first signalling point, and sending the DUPU message to the forwarding unit; and

the forwarding unit is capable of forwarding the DUPU message according to the originating point code which is carried along with the DUPU message.

The forwarding unit includes: a judging unit, a message handling unit and a message forwarding unit, and,

the judging unit is capable of judging whether the originating point code which is carried along with the DUPU message is identical with the signalling point code of the local signalling point, sending the DUPU message to the message handling unit if the originating point code is identical with the signalling point code of the local signalling point, otherwise sending the DUPU message to the message forwarding unit;

the message processing unit is capable of handling the DUPU message locally; and

the message forwarding unit is capable of forwarding the DUPU message to the signalling point corresponding to the originating point code.

A general signalling point according to the present invention includes: a sending and receiving unit and a forwarding unit;

the sending and receiving unit is capable of receiving a Destination User Part Unavailable (DUPU) message, and sending the DUPU message to the forwarding unit;

the forwarding unit is adapted to forward the DUPU message according to the originating point code which is carried along with the DUPU message.

The forwarding unit includes: a judging unit, a message handling unit and a message forwarding unit;

the judging unit is capable of judging whether the originating point code which is carried along with the DUPU message is identical with the signalling point code (SPC) of the local signalling point, sending the DUPU message to the message handling unit if the originating point code is identical with the SPC of the local signalling point, otherwise sending the DUPU message to the message forwarding unit;

the message handling unit is capable of handling the DUPU message locally; and

the message forwarding unit is capable of forwarding the DUPU message to the signalling point corresponding to the originating point code.

The signalling point further includes:

a failure handling unit, capable of carrying along with the DUPU message the originating point code corresponding to the originating signalling point which has triggered the DUPU message, and returning the DUPU message when a User Part is unavailable.

In accordance with the embodiments of the present invention, it can be seen that a first signalling point in which a User Part is unavailable not only returns a DUPU message, but also carries the originating point code corresponding to the originating signalling point which has triggered the DUPU message in the DUPU message to be sent. Therefore a second signalling point may learn the destination signalling point corresponding to the DUPU message upon receiving the DUPU message, and thus the DUPU message may be correctly forwarded. When the DUPU message is forwarded to the correct signalling point which triggered the message, the signalling point may inform corresponding User layer and thus the User layer may stop sending messages to the User of the first signalling point in which the User Part is unavailable. Therefore, the workload in forwarding messages is lightened, and waste of transport resources is reduced.

### BRIEF DESCRIPTION OF THE DRAWINGS

FIG. 1 is a schematic diagram illustrating the network structure in the prior art.

FIG. 2 is a flow chart illustrating the method for transporting DUPU message in accordance with an embodiment of the present invention.

FIG. 3 is a schematic diagram illustrating the structure of the system for transporting DUPU message in accordance with an embodiment of the present invention.

FIG. 4 is a schematic diagram illustrating the structure of the signalling point in accordance with an embodiment of the present invention.

FIG. 5 is a flow chart illustrating the method for transporting DUPU message in accordance with an embodiment of the present invention.

FIG. 6 is a flow chart illustrating the method for transporting DUPU message in accordance with an embodiment of the present invention.

### EMBODIMENTS OF THE INVENTION

In order to make the technical solutions and advantages of the present invention clearer, the present invention is hereinafter described in detail with reference to the drawings and embodiments.

As shown in FIG. 2, the method for transporting a DUPU message in accordance with an embodiment of the present invention comprises the following steps as indicated in the blocks of FIG. 2.

Block 201: A first signalling point in which a User Part is unavailable returns a DUPU message to a second signalling point. An originating point code corresponding to the originating signalling point which has triggered the DUPU message is carried along with the DUPU message.

Block 202: Upon receiving the DUPU message, the second signalling point forwards the DUPU message according to the originating point code which is carried along with the message.

The step of receiving and forwarding according to block 202 further includes: the second signalling point judges whether the originating point code which is carried along with the message is identical with the SPC of the second, or local, signalling point, and handles the received DUPU message locally if the originating point code is identical with the SPC of the local signalling point, otherwise forwards the received DUPU message to the signalling point which corresponds to the originating point code.

The second signalling point is a signalling point sending or forwarding a DATA message to the first signalling point. When the first signalling point detects a failure in delivering message from the second signalling point to the designated upper-layer user, the first signalling point returns the DUPU message to the second signalling point.

The above mentioned signalling point may be any signalling point SP or any Signalling Gateway SG.

The above method of carrying the originating point code corresponding to the originating signalling point which has triggered the DUPU message may be implemented by extending the DUPU message. There are multiple ways of extending the DUPU message, and the following are some illustrative examples.

As shown in Table 2, a field is added to the existing DUPU message and is used for carrying the originating point code corresponding to the originating signalling point which has triggered the DUPU message. A first signalling point in which a User Part is unavailable includes the originating point code in the newly added field and sends the message to the second signalling point.

TABLE 2

| | | | |
|---|---|---|---|
| 0 | 1 | 2 | 3 |

| | |
|---|---|
| Tag = 0x0200 | Length = 8 |

Network Appearance

| | |
|---|---|
| Tag = 0x0006 | Length |

Routing Context

| | |
|---|---|
| Tag = 0x0012 | Length = 8 |

| | |
|---|---|
| mask = 0 | Affected PC |

| | |
|---|---|
| Tag = 0x0206 | Length = 8 |

| | |
|---|---|
| Reserved | Concerned DPC |

| | |
|---|---|
| Tag = 0x0204 | Length = 8 |
| Cause | User |
| Tag = 0x0004 | Length |

INFO String

In Table 2, the Concerned Destination Point Code (Concerned DPC) field is the newly added field used for carrying the originating point code. The tag of the field is 0x0206 and the size of the field is 8 bytes. The Concerned DPC field is clearly defined in M3UA protocol, and is used in an SCON message for forwarding the SCON message. In accordance with an embodiment of the present invention, the Concerned DPC field is added to the DUPU message for forwarding the DUPU message.

It should be noted that the newly added Concerned DPC field may be placed at any part of the DUPU message and is not limited to the position shown in Table 2.

Another proposed embodiment teaches that the INFO String field in a DUPU message may also be extended and a first signalling point may send the extended INFO String field carrying the originating point code corresponding to the originating signalling point which has triggered the DUPU message. According to the definition in M3UA protocol, the INFO String field may carry any 8-bit ASCII string that makes sense and the length of the field may range between 0 and 255, leaving room for internal debugging and future extension. The field may be extended to be compatible with old-fashioned equipment. The old-fashioned equipment which does not support the extension may simply leave the INFO String field intact without changing the original procedures.

There are also multiple ways of extending the INFO String field. For example, according to the message format defined in M3UA, the DUPU message may be extended into a format of a fixed-size, as shown in Table 3, or be extended into a format with an indefinite size, as shown in Table 4. The format of fixed-size means the size of the Concerned DPC field is a fixed value, and the format with indefinite size means the size of the Concerned DPC field is variable. The extension may even go beyond the message format defined in M3UA into the message format shown in Table 5.

TABLE 3

| | | | |
|---|---|---|---|
| 0 | 1 | 2 | 3 |

| | |
|---|---|
| Tag = 0x0200 | Length = 8 |

Network Appearance

| | |
|---|---|
| Tag = 0x0006 | Length |

Routing Context

| | |
|---|---|
| Tag = 0x0012 | Length = 8 |

| | |
|---|---|
| mask = 0 | Affected PC |

| | |
|---|---|
| Tag = 0x0204 | Length = 8 |
| Cause | User |
| Tag = 0x0004 | Length = 12 |

Concerned DPC Tag
Concerned DPC

TABLE 4

| | | | |
|---|---|---|---|
| 0 | 1 | 2 | 3 |

| | |
|---|---|
| Tag = 0x0200 | Length = 8 |

Network Appearance

| | |
|---|---|
| Tag = 0x0006 | Length |

Routing Context

| | |
|---|---|
| Tag = 0x0012 | Length = 8 |

| | |
|---|---|
| mask = 0 | Affected PC |

| | |
|---|---|
| Tag = 0x0204 | Length = 8 |
| Cause | User |
| Tag = 0x0004 | Length = 12 |
| Concerned DPC Tag | Length = 8 |

Concerned DPC

TABLE 5

| | | | |
|---|---|---|---|
| 0 | 1 | 2 | 3 |

| | |
|---|---|
| Tag = 0x0200 | Length = 8 |

Network Appearance

| | |
|---|---|
| Tag = 0x0006 | Length |

Routing Context

| | |
|---|---|
| Tag = 0x0012 | Length = 8 |

| | |
|---|---|
| mask = 0 | Affected PC |

| | |
|---|---|
| Tag = 0x0204 | Length = 8 |
| Cause | User |
| Tag = 0x0004 | Length = 8 |

| | |
|---|---|
| Reserved | Concerned DPC |

An embodiment is described hereinafter to further illustrate the method provided by the present invention.

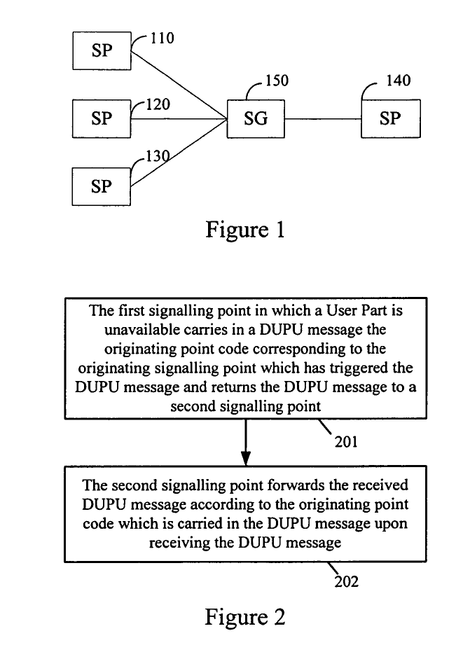

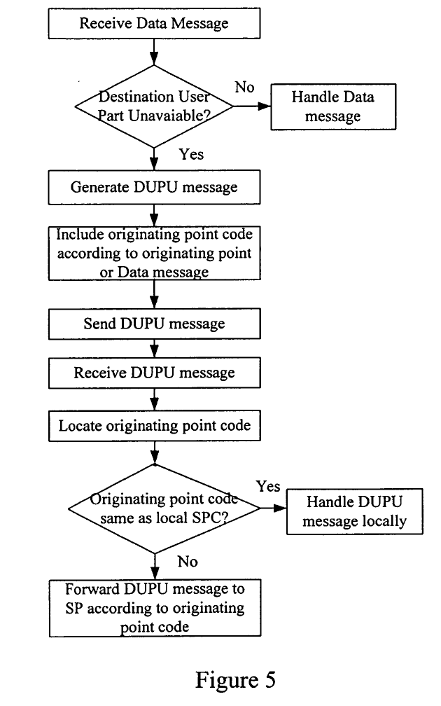

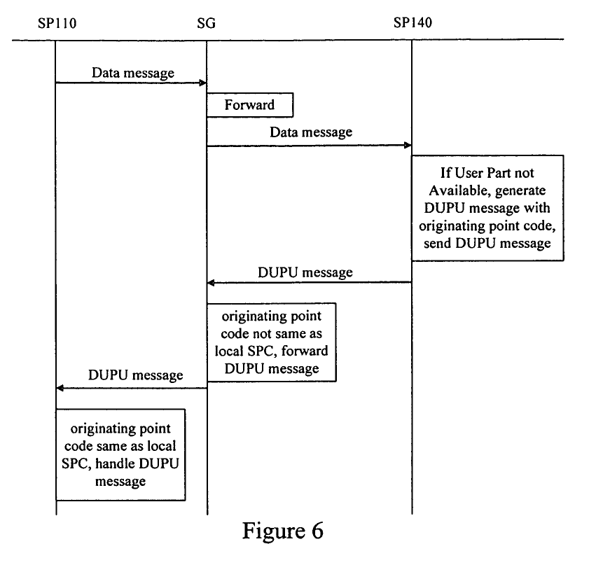

In the network structure as shown in FIG. 1 and flow charts as shown in FIG. 5 and FIG. 6, when SP 140 receives a DATA message from SP 110 via the SG 150 and detects a failure in transporting the message to the upper-layer user, i.e., a User Part is unavailable, SP 140 sends a DUPU message to the SG 150. The DUPU message carries the originating point code corresponding to the originating signalling point which has triggered the DUPU message, i.e., the code of the originating signalling point, SP 110, of the DATA message, in the Concerned DPC field for example. The Affected PC field of the DUPU message shall carry the SPC of SP 140.

Upon receiving the DUPU message from SP 140, the SG 150 first locates and parses the Concerned DPC field, determines whether the originating point code carried in the Concerned DPC field is identical with the SPC of the SG 150. If the originating point code is identical with the SPC of the SG 150, the SG 150 handles the DUPU message locally and informs the corresponding local User layer of the SG 150 that the user of SP 140 is unavailable according to the User field contained in the DUPU message, and the User layer of the SG 150 receives the information and stops sending the DATA message to the user of SP 140 accordingly. If the originating point code is not identical with the SPC of the SG 150, the SG 150 forwards the received DUPU message to the signalling point corresponding to the originating point code which is contained in the DUPU message, e.g. an SP or an SG. In this embodiment, the SG 150 will forward the DUPU message from SP 140 to SP 110. Upon receiving the forwarded DUPU message, SP 110 informs corresponding local User layer that the user of SP 140 is unavailable according to the User field in the DUPU message. The User layer of SP 110 will stop sending the DATA message to the user of SP 140 when the information is received.

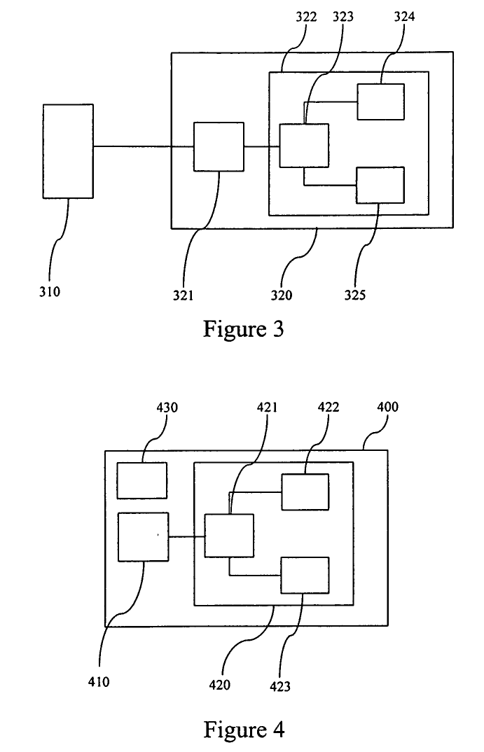

The present invention also provides a system for transporting a DUPU message. As shown in FIG. 3, the system mainly comprises: a first signalling point 310 and a second signalling point 320. The first signalling point 310 is used to return a DUPU message when a User Part is unavailable. The DUPU message carries the originating point code corresponding to the originating signalling point which has triggered the DUPU message. The second signalling point 320 is used to receive the DUPU message from the first signalling point 310, and to forward the received DUPU message according to the originating point code which is carried along with the message.

The second signalling point 320 further includes: a sending and receiving unit 321 and a forwarding unit 322. The sending and receiving unit 321 is used to receive the DUPU message from the first signalling point 310 and to send the received DUPU message to the forwarding unit 322. The forwarding unit 322 is used to forward the received DUPU message according to the originating point code which is contained in the message.

The forwarding unit 322 further includes: a judging unit 323, a message handling unit 324 and a message forwarding unit 325. The judging unit 323 is used to judge whether the originating point code which is contained in the received DUPU message is identical with the SPC of the second, or local signalling point 320, to deliver the received DUPU message to the message handling unit 324 if the originating point code is identical with the SPC of the local signalling point, and to deliver the received DUPU message to the message forwarding unit 325 if the originating point code is not identical with the SPC of the local signalling point. The message handling unit 324 is used to handle the received DUPU message locally. The message forwarding unit 325 is used to forward the received DUPU message to the signalling point corresponding to the originating point code.

Embodiments of the present invention also provide a signalling point. As shown in FIG. 4, the signalling point 400 includes: a sending and a receiving unit 410 and a forwarding unit 420. The sending and receiving unit 410 is used to receive the DUPU message and sending the received DUPU message to the forwarding unit 420. The forwarding unit 420 is used to forward the received DUPU message according to the originating point code which is carried along with the DUPU message.

The forwarding unit 420 further includes: a judging unit 421, a message handling unit 422 and a message forwarding unit 423. The judging unit 421 is used to judge whether the originating point code which is contained in the received DUPU message is identical with the SPC of the local signalling point, to deliver the received DUPU message to the message handling unit 422 if the originating point code is identical with the SPC of the local signalling point, and to deliver the received DUPU message to the message forwarding unit 423 if the originating point code is not identical with the SPC of the local signalling point. The message handling unit is used to handle the received DUPU message locally. The message forwarding unit is used to forward the received DUPU message to the signalling point corresponding to the originating point code.

The signalling point further includes: a failure handling unit 430, for returning a DUPU message carrying originating point code corresponding to the originating signalling point which has triggered the DUPU message when a User Part is unavailable.

The purpose, technical solution and merits of the present invention have been further described in detail with the above description. It should be appreciated that the foregoing is not for use in limiting the present invention. Any modification, equivalent substitution, improvement within the principle of the present invention should be covered in the protection scope of the present invention as defined by the accompanying claims.

What is claimed is:

1. A method for transporting a Destination User Part Unavailable, DUPU, message, comprising:
returning, by a first signalling point in which a User Part is unavailable, a DUPU message to a second signalling point, the DUPU message carrying a originating point code corresponding to the originating signalling point which has triggered the DUPU message;
forwarding, by the second signalling point, the DUPU message according to the originating point code which is carried along with the DUPU message upon receiving the DUPU message.

2. The method of claim 1, wherein forwarding the DUPU message by the second signalling point comprises:
judging, by the second signalling point, whether the originating point code which is carried along with the DUPU message is identical with the signalling point code, SPC, of the second signalling point; and
handling the received DUPU message locally if the originating point code is identical with the SPC of the second signalling point, or
forwarding the received DUPU message to the signalling point corresponding to the originating point code if the originating point code is not identical with the SPC of the second signalling point.

3. The method in claim 2, wherein the carrying along with the DUPU message the originating point code by the first signalling point comprises:
adding, by the first signalling point, a field for carrying the originating point code in the DUPU message, and sending the DUPU message.

4. The method in claim 2, wherein the carrying along with the DUPU message the originating point code by the first signalling point comprises:
extending, by the first signalling point, the INFO String field of the DUPU message to carry the originating point code and sending the DUPU message carrying the originating point code in the extended INFO String field.

5. The method in claim 1, wherein the carrying along with the DUPU message the originating point code by the first signalling point comprises:
adding, by the first signalling point, a field for carrying the originating point code in the DUPU message, and sending the DUPU message.

6. The method in claim 1, wherein the carrying along with the DUPU message the originating point code by the first signalling point comprises:
extending, by the first signalling point, the INFO String field of the DUPU message to carry the originating point code and sending the DUPU message carrying the originating point code in the extended INFO String field.

7. A system for transporting Destination User Part Unavailable, DUPU, message, comprising: a first signalling point and a second signalling point, wherein:
the first signalling point is capable of carrying along with a DUPU message the originating point code corresponding to the originating signalling point which has triggered the DUPU message when a User Part is unavailable, and returning the DUPU message to the second signalling point; and
the second signalling point is capable of receiving the DUPU message from the first signalling point, and forwarding the DUPU message according to the originating point code which is carried along with the DUPU message.

8. The system in claim 7, wherein the second signalling point comprises: a sending and receiving unit and a forwarding unit, and that,
the sending and receiving unit is capable of receiving the DUPU message from the first signalling point, and sending the DUPU message to the forwarding unit; and that
the forwarding unit is capable of forwarding the DUPU message according to the originating point code which is carried along with the DUPU message.

9. The system in claim 8, wherein the forwarding unit comprises: a judging unit, a message handling unit and a message forwarding unit, wherein,
the judging unit is capable of judging whether the originating point code which is carried along with the DUPU message is identical with the signalling point code of the local signalling point, sending the DUPU message to the message handling unit if the originating point code is identical with the signalling point code of the local signalling point, otherwise sending the DUPU message to the message forwarding unit;
the message processing unit is capable of handling the DUPU message locally; and
the message forwarding unit is capable of forwarding the DUPU message to the signalling point corresponding to the originating point code.

10. A signalling point, comprising: a sending and receiving unit and a forwarding unit, wherein,
the sending and receiving unit is capable of receiving a Destination User Part Unavailable, DUPU, message, and sending the DUPU message to the forwarding unit; and
the forwarding unit is capable of forwarding the DUPU message according to the originating point code which is carried along with the DUPU message.

11. The signalling point in claim 10, wherein the forwarding unit comprises: a judging unit, a message handling unit and a message forwarding unit;
that the judging unit is capable of judging whether the originating point code which is carried along with the DUPU message is identical with the signalling point code, SPC, of the local signalling point, sending the DUPU message to the message handling unit if the originating point code is identical with the SPC of the local signalling point, otherwise sending the DUPU message to the message forwarding unit;
that the message handling unit is capable of handling the DUPU message locally; and
that the message forwarding unit is capable of forwarding the DUPU message to the signalling point corresponding to the originating point code.

12. The signalling point of claim 10, wherein it further comprises a failure handling unit, capable of carrying along with the DUPU message the originating point code corresponding to the originating signalling point which has triggered the DUPU message, and returning the DUPU message when a User Part is unavailable.
